(19) United States
(12) Patent Application Publication
(10) Pub. No.: US 2026/0307487 A1
(43) Pub. Date: Oct. 8, 2026

(54) INFORMATION PROCESSING DEVICE

(71) Applicant: TOYOTA JIDOSHA KABUSHIKI KAISHA, Toyota-shi (JP)

(72) Inventors: Aya YAMADA KAMISAKA, Tokyo (JP); Takayuki Yamabe, Tokyo (JP); Kota Hoshiba, Tokyo (JP); Ryota Nakanishi, Tokyo (JP); Hajime Tojiki, Tokyo (JP)

(73) Assignee: TOYOTA JIDOSHA KABUSHIKI KAISHA, Toyota-shi (JP)

(21) Appl. No.: 19/447,129

(22) Filed: Jan. 13, 2026

(30) Foreign Application Priority Data
Apr. 8, 2025 (JP) 2025-063789

(51) Int. Cl. B60K 35/29; B60K 35/10

(52) U.S. Cl. CPC B60K 35/29; B60K 35/10

(57) ABSTRACT

An information processing device includes a control unit configured to execute proposing information to a user, setting, after the information proposal, a response period for detecting that the user has taken a response behavior toward the proposal of the information, acquiring feedback data expressing the behavior of the user in the response period, and determining whether the user has taken the response behavior based on the feedback data. The control unit is configured to further execute adjusting the length of the response period in accordance with content of the proposal of the information in setting of the response period.

### CROSS-REFERENCE TO RELATED APPLICATION

This application claims priority to Japanese Patent Application No. 2025-063789 filed on Apr. 8, 2025. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

When information is proposed to a user, it is useful to detect a response behavior of the user toward the proposal from the perspective of improvement in accuracy of the proposal of information and the like. Regarding the above, for example, in Japanese Unexamined Patent Application Publication No. 2022-144312 (JP 2022-144312 A), a technology of inferring whether a user exposed to an advertisement got interested in the advertisement is disclosed. In this technology, when a behavior such as related keyword search is performed within a predetermined period of time after the exposure to the advertisement, it is determined that the user has taken a response behavior toward the advertisement, in other words, the user is interested in the advertisement.

### SUMMARY

In order to suitably detect the response behavior of the user, the setting of a period of time (hereinafter referred to as a "response period") for the detection becomes important. There is a risk of overlooking a response of the user when the response period is too short, and an unnecessary response of the user is detected when the response period is unnecessarily long.

An object of the present disclosure is to suitably detect a response of a user to proposal of information performed toward the user.

An aspect of the present disclosure is an information processing device including a control unit configured to execute proposing information to a user, setting, after the proposal of the information, a response period for recognizing that the user has taken a response behavior toward the proposal of the information, acquiring feedback data expressing the behavior of the user in the response period, and determining whether the user has taken the response behavior based on the feedback data and outputting a determination result. In the information processing device, the control unit is configured to further execute adjusting the length of the response period in accordance with content of the proposal of the information in the setting of the response period.

Another aspect is a program that makes a computer execute a method executed by the above-described information processing device, or a computer-readable storage medium that non-transitorily stores that program.

According to the present disclosure, it becomes possible to suitably detect the response of the user to the proposal of the information performed toward the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of an information proposal system of the present disclosure;

FIG. 2 is a diagram illustrating the hardware configuration of an in-vehicle device;

FIG. 3 is a diagram illustrating the software configuration of the in-vehicle device;

FIG. 4 is a first flowchart relating to processing for information proposal executed by the in-vehicle device;

FIG. 5 is a diagram illustrating coordination between software modules included in the in-vehicle device in the processing of the information proposal; and

FIG. 6 is a second flowchart relating to the processing for the information proposal executed by the in-vehicle device.

### DETAILED DESCRIPTION OF EMBODIMENTS

In recent years, products installed with a language model are increasing along with the development of machine learning. For example, a dialogue function by a natural language can be added to an applicable product by incorporating machine learning using a large-scale dataset of which accuracy is enhanced by a large language model (hereinafter referred to as an LLM) in the product. A field in which dialogue by a natural language is useful is the automotive field. For example, by installing the LLM in an in-vehicle device, it becomes possible to obtain information without operating a touchscreen and the like. Such a function is especially useful when hands cannot be used such as during traveling. For example, a dialogue function by a natural language may be installed in incorporated equipment (for example, the in-vehicle device) in the vehicle. However, regarding a trained LLM, an approach of accessing the LLM via a network can be employed instead of the above from the perspective of data size and cost. By accessing the LLM via the network, it becomes possible to use a large-scale language model that is difficult to be installed in a local storage.

It is becoming possible to propose various information to the user with the improvement of the dialogue function by a natural language as above or in cases that are not limited to a case of using the dialogue function by a natural language. It can be conceived to be important to grasp how a user has responded to the information proposal toward the user from the perspective of suitable information proposal. However, it is hard to say that the detection of the response is satisfactorily performed. For example, when a period of time for detecting the response of the user becomes excessively long, the connection with the behavior of the user toward to the proposal becomes unclear, and there is a risk that a behavior of the user other than the response to the proposal may be detected. Meanwhile, when a period of time for detecting the response of the user becomes too short, the movement of the user cannot be detected even when the user has been trying to respond to the proposal.

The user may be in various situations when the information is proposed to the user, and it is not always possible for the user to show a certain response. Thus, the information processing device according to the present disclosure solves problems as above.

An information processing device according to an aspect of the present disclosure includes a control unit configured to execute proposing information to a user, setting, after the proposal of the information, a response period for detecting that the user has taken a response behavior toward the proposal of the information, acquiring feedback data expressing the behavior of the user in the response period, and determining whether the user has taken the response behavior based on the feedback data. The control unit is configured to further execute adjusting the length of the response period in accordance with content of the proposal of the information in the setting of the response period.

Various forms can be employed regarding the proposal of information to the user. For example, an external agent disposed outside the information processing device can be used. For example, the external agent may be a system that is capable of having a dialogue by a natural language and provides a proposal service with use of language models each specialized in a corresponding one of a plurality of domains (fields). The language model may be a large language model. The large language model is a language model trained such that a dialogue task by a natural language is executable, for example. Examples of domains that the external agents are in charge include "route guidance", "regional information guidance", "vehicle handling guide", "tourist guidance", and "casual conversation". Typically, the external agents as above can be remotely accessed via a network.

As another method, the information proposal to the user can also be executed with use of a local agent included in the information processing device. The local agent included in the information processing device is a language model capable of executing a dialogue task by a natural language, but can be a language model on which training specialized in a specific domain has not been performed and which can be generated at a relatively low cost unlike the external agent, for example.

The feedback data is information indicating a behavior of the user, and examples thereof include information indicating content of an utterance of the user, information indicating a gesture, information about an operation action of the user on the information processing device or a peripheral device and the like related to the information processing device by the user.

After the proposal of information is made to the user, the control unit sets a response period for detecting a response behavior of the user toward the proposal, and adjusts the length of the response period in accordance with the content of the proposal of information. In other words, the length of a response period is adjusted, and then the response period is set in order to detect a response behavior. The content of the proposal may encourage the user to quickly respond or may allow a response over a relatively long period of time. Examples of the case of the former include a case in which traveling to a facility and the like close to the location of the user at the time of the proposal is proposed. Examples of the case of the latter include a case in which a behavior of the user after several months is proposed. The control unit performs the setting after adjusting the length of the response period in consideration of the connection between the content of the proposal of information and the response behavior expected from the user as above. By employing this configuration, the information processing device can suitably acquire feedback data that may include the response behavior of the user toward the proposal.

Then, the control unit determines whether the user has taken a response behavior toward the proposal based on the acquired feedback data, in other words, determines whether behavioral information of the user that can be determined to be a response behavior is included in the acquired feedback data. As a result, it becomes possible to suitably detect the response of the user to the proposal of the information performed toward the user. The determination result obtained by the control unit can be suitably used by being output in order to improve the information proposal to the user, for example.

Specific embodiments of the present disclosure will be described below with reference to the drawings. The hardware configuration, the module configuration, the function configuration, and the like described in each embodiment are not intended to limit the technical scope of the disclosure thereto unless otherwise stated.

### First Embodiment

### Outline of System

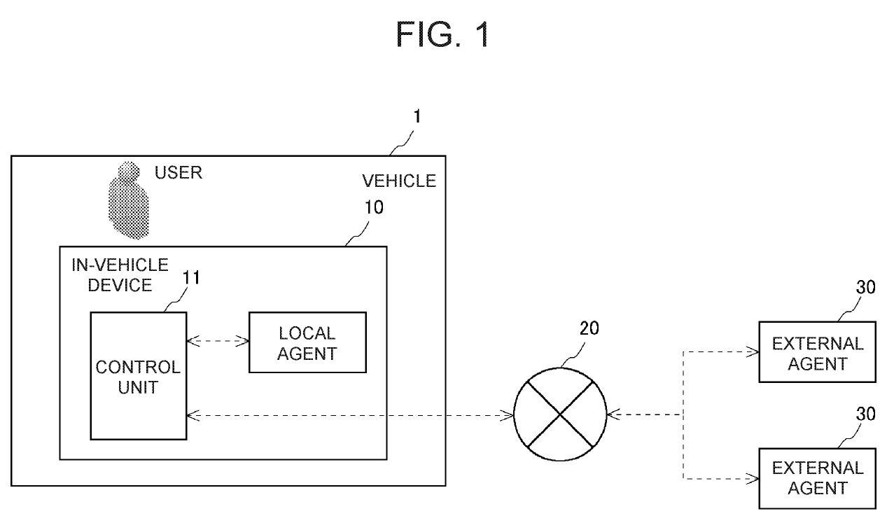

A schematic configuration of a proposal system according to a first embodiment is described with reference to FIG. 1. The proposal system according to the present embodiment is configured to include an in-vehicle device 10 installed in a vehicle 1. The in-vehicle device 10 can access an agent (external agent 30) that provides an information proposal service by a natural language via a network (for example, a mobile communication network) 20.

The in-vehicle device 10 is installed in a connected vehicle capable of communicating with a freely selected device via wireless communication. The in-vehicle device 10 may include a data communication module (DCM) for connecting components (for example, an ECU and the in-vehicle device) included in the vehicle 1 and the network 20 to each other. In the present embodiment, the in-vehicle device 10 can access the Internet via the network 20 by the wireless communication, and connect to the external agent 30 and the like that provide a proposal service.

The vehicle 1 (or the components installed in the vehicle) can provide various services by communicating with external devices via the in-vehicle device 10. Examples of various services include a navigation service, a remote control (for example, remote air conditioning) service, an in-vehicle Wi-Fi (R) service, and an emergency call service.

The in-vehicle device 10 has a speech input/output function and can have a dialogue with an occupant of the vehicle by a natural language. The in-vehicle device 10 is configured to have a control unit 11 for performing input/output of speech and speech recognition and a local agent. The local agent includes a language model trained such that a dialogue by a natural language becomes possible. The local agent may provide predetermined functions such as route search and the operation of the vehicle (an air conditioner and the like) via a dialogue, for example. As with the external agent 30, the local agent is configured to be able to provide an information proposal service by a natural language. The language model used by the local agent is stored in a storage device included in the in-vehicle device 10.

Here, the size of the language model used in the information proposal service through a dialogue by a natural language greatly varies in accordance with the function thereof. For example, there is a wide range of categories of the dialogue such as regional information and tourist guidance, information about the vehicle (an operation manual), and casual conversation, but a language model trained with use of large-scale training data needs to be prepared in order to cover all of those categories. Such a language model may range from several gigabytes to several hundred gigabytes in size, and hence is difficult to be installed in the in-vehicle device 10 with limited capacity. Thus, a proposal service function using a large language model is set in the external agent 30. Meanwhile, a relatively small language model is installed in the in-vehicle device 10, and the information proposal service by a natural language corresponding to requests from limited users, for example, is realized by using the relatively small language model.

In the description of the present embodiment, terms such as access to the external agent and connection to the external agent mean access and connection to the external device that provides a proposal service by the external agent. In the present embodiment, a plurality of proposal services by a large language model is in operation as an "external agent" in each of a plurality of external devices, and the in-vehicle device 10 can have a dialogue by connecting to a freely selected external agent.

### Hardware Configuration

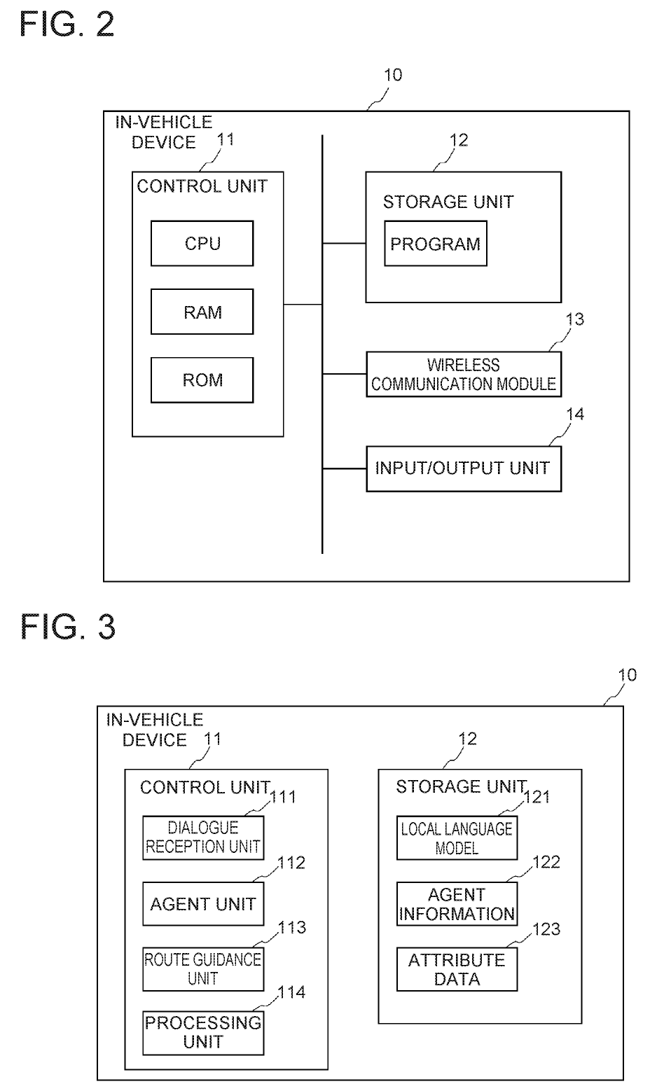

Next, the hardware configuration of each device configuring the proposal system is described. FIG. 2 is a diagram schematically illustrating one example of the configuration of hardware included in the in-vehicle device 10 according to the present embodiment.

The in-vehicle device 10 can be configured as a computer having a processor (a CPU, a GPU, etc.), a main storage device (an RAM, an ROM, etc.), and an auxiliary storage device (an EPROM, a hard disc drive, a removable medium, etc.). In the auxiliary storage device, an operating system (OS), various programs, various tables, and the like are stored, and each function (software module) that matches a predetermined purpose can be realized as described later by executing the programs stored therein. Note that some or all of the functions may be realized as hardware modules by hardware circuits such as an ASIC and an FPGA.

The in-vehicle device 10 is configured to have the control unit 11, a storage unit 12, a wireless communication module 13, and an input/output unit 14 as hardware.

The control unit 11 is an arithmetic unit that realizes various functions of the in-vehicle device 10 by executing a predetermined program. The control unit 11 can be realized by a hardware processor such as a CPU, for example. The control unit 11 may be configured to include a RAM, a Read Only Memory (ROM), a cache memory, and the like.

The storage unit 12 is means for storing information, and is configured by a storage medium such as a RAM, a magnetic disk, and a flash memory. In the storage unit 12, a program to be executed by the control unit 11, data and the like to be used by the program are stored.

The wireless communication module 13 is a communication device that performs wireless communication with a predetermined network. In the present embodiment, the wireless communication module 13 is configured to be able to communicate with the network 20 that is a mobile communication network. The wireless communication module 13 can be configured to have an eUICC (for example, a SIM card). The SIM card is configured as a microcomputer including a CPU and a storage device. The SIM card stores therein information used for connecting to the network 20 and being authenticated.

The input/output unit 14 is a unit that receives an input from a user of the device and presents information to the user. The input/output unit 14 is typically configured to include devices for inputting and outputting speech such as a microphone and a speaker. The input/output unit 14 may also include a device (a display and the like) that provides visual information.

### Software Configuration

Next, the software configuration of each device configuring the system is described. FIG. 3 is a diagram schematically illustrating the software configuration of the in-vehicle device 10 according to the present embodiment. In the present embodiment, the control unit 11 included in the in-vehicle device 10 is configured to have four software modules, that is, a dialogue reception unit 111, an agent unit 112, a route guidance unit 113, and a processing unit 114. Each software module may be realized by executing the program stored in the storage unit 12 by the control unit 11 (the CPU and the like). Information processing executed by the software module is synonymous with information processing executed by the control unit 11 (the CPU and the like).

The dialogue reception unit 111 acquires an utterance made by the occupant of the vehicle (hereinafter also referred to as a user) via the input/output unit 14. The dialogue reception unit 111 executes predetermined processing on acquired speech data and executes speech recognition. As a result, the content of the utterance is converted to text. The dialogue reception unit 111 transmits the text obtained as the result of the speech recognition to the agent unit 112. The dialogue reception unit 111 outputs a response (hereinafter referred to as an answer sentence) from the language model transmitted from the agent unit 112 in a form of speech and display on the display.

The agent unit 112 provides an information proposal service. Specifically, the agent unit 112 provides an information proposal service using a language model (a local language model 121 described later) stored in its own device. The agent unit 112 can behave as a virtual agent (local agent). The local agent can provide, for example, a proposal service that completes in its own device (for example, a casual conversation). When a specialized knowledge is necessary in the dialogue, the agent unit 112 realizes the information proposal service by transmitting an uttered sentence to one or more external agents 30 that can be used via the network 20, acquiring a result thereof, and providing the result to the user. For example, when it is determined that the user is requesting information about the vehicle 1, the agent unit 112 selects the external agent 30 capable of providing a handling guide of the vehicle 1. When it is determined that the user is requesting information about a facility or a store, the agent unit 112 selects the external agent 30 capable of providing the information. The selection of the external agent 30 may be performed based on a result obtained by analyzing the content of the utterance. The agent unit 112 may obtain the fitness for each of the plurality of external agents 30 based on words and context included in the uttered sentence, and may transmit the uttered sentence to the external agent 30 for which a fitness of a predetermined value or more is obtained, for example.

The route guidance unit 113 receives the designation of an origin and a destination from the user or receives an instruction (for example, an instruction for setting location information of a destination and the like to be recommended to the user) from the agent unit 112, and generates a route connecting the origin and the destination to each other based on road map data and the like. The route guidance unit 113 outputs information about the generated route via the input/output unit 14.

The processing unit 114 detects a response behavior of the user toward the information proposal service executed by the agent unit 112. Specifically, after the information proposal service is set from the agent unit 112, a response period for detecting the response behavior of the user is set. Regarding the response period, in order to suitably acquire the response behavior of the user, the length of the response period is adjusted in accordance with the information content in consideration of a connection between information content that is proposed and a response behavior expected from the user. The processing unit 114 acquires feedback data indicating the behavior of the user in the set response period, and determines whether there is a response to the information proposal based on the acquired feedback data. The feedback data includes behavioral information of the user (information about an utterance of the user through the microphone and information about an operation and the like of a predetermined button provided in the in-vehicle device 10) obtained through the input/output unit 14, information from a sensor (not shown) (imaging information and the like of a camera that images the behavior, the expression, and the like of the user), information about the operation of the vehicle 1 by the user. Details of the processing by the processing unit 114 is described later.

The storage unit 12 included in the in-vehicle device 10 stores therein the local language model 121, agent information 122, and attribute data 123. The local language model 121 is a language model trained such that a dialogue task by a natural language is executable. The local language model 121 is a language model generated at a relatively low cost, and only needs to be a language model for having a general conversation, for example. The local language model 121 is a language model that is more lightweight than the large language model included in the external agent that can be accessed via the network. As a result of the agent unit 112 using the local language model 121, it becomes possible to have a dialogue with satisfactory response. For example, appropriate use depending on the situation where the uttered sentence is transmitted to the external agent when a specialized conversation is necessary, and the local agent processes the uttered sentence for a conversation that requires a quick response becomes possible.

The agent information 122 is a set of data relating to a plurality of external agents that can be used by the in-vehicle device 10. Examples of the agent information 122 may include information about identifiers, names, and specialized domains of the external agents, information about access destinations (for example, network addresses of external devices that provide the external agents). The agent unit 112 can determine the external agent that serves as a transmission destination of the uttered sentence by referring to the agent information 122.

The attribute data 123 is a set of data relating to attributes of the user that has a dialogue with the in-vehicle device 10. Examples of the attribute data 123 may include personal information such as gender, age, height, and weight of the user. When there is a plurality of users of the vehicle, the attribute data 123 may also include data of a plurality of people.

### Flow of Information Proposal to User and Response Behavior of User

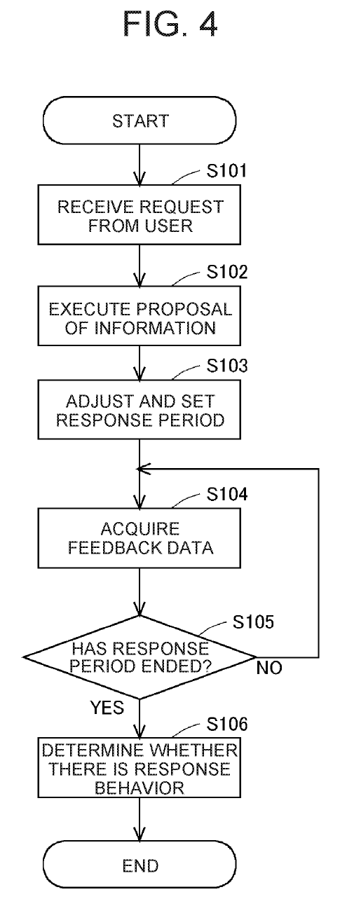

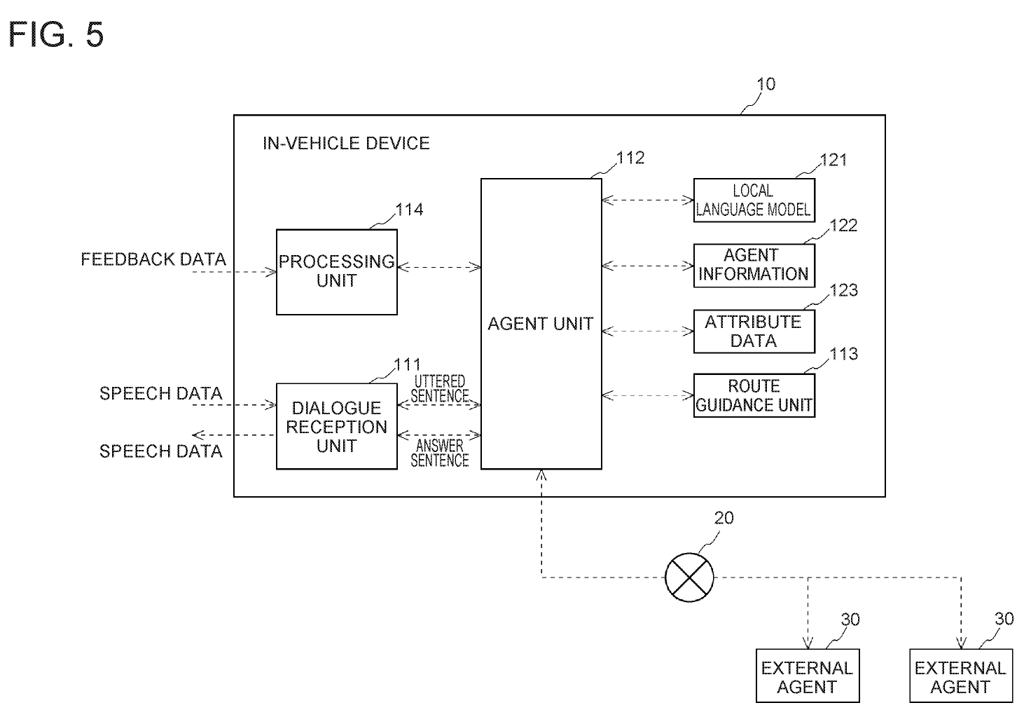

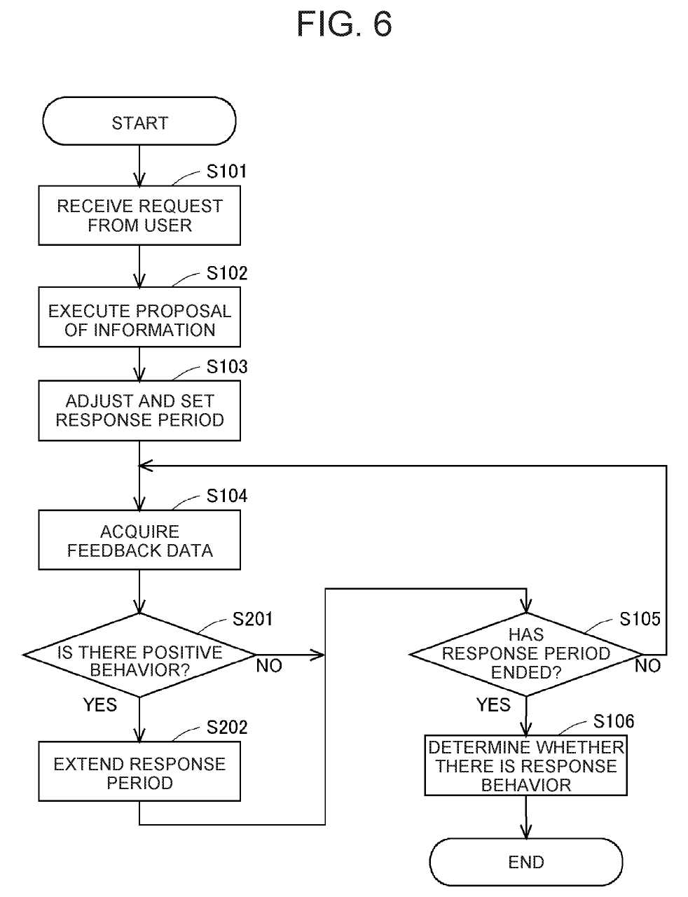

Here, FIG. 4 is a flowchart illustrating the flow of processing of information proposal to the user, and FIG. 5 is a diagram illustrating each software module in a coordination between the control unit 11 of the in-vehicle device 10 in the processing of information proposal. The flow of the processing executed by the control unit 11 is described based on those diagrams. The processing illustrated in the flowchart in FIG. 4 is started from a starting point of a request to the in-vehicle device 10 by the user (request for information proposal) as one example.

First, in step S101, a request regarding information proposal from the user in the vehicle 1 is received. The processing is performed by the dialogue reception unit 111. Specifically, the dialogue reception unit 111 acquires an utterance relating to the request from the user via the input/output unit 14. For example, the input/output unit 14 converts the utterance acquired via the microphone and the like to speech data, and the dialogue reception unit 111 acquires the speech data. The dialogue reception unit 111 executes predetermined speech recognition processing on the acquired speech data and converts the speech data to text. The dialogue reception unit 111 transmits the text obtained as a result of the speech recognition to the agent unit 112 while holding a response to the utterance. The text is referred to as an "uttered sentence".

Next, in step S102, the agent unit 112 executes information proposal processing based on the uttered sentence transmitted by the dialogue reception unit 111. Specifically, the agent unit 112 that has received the uttered sentence grasps the request of the user based on the content of the utterance, acquires the agent information 122 about the external agents from the storage unit 12, and determines the external agent 30 that is the transmission destination of the uttered sentence with use of the agent information 122. The intention of the utterance may be determined with use of the local language model 121 or may be determined with use of another machine learning model. The determination may be performed in a rule-based manner. The agent unit 112 acquires the information about the external agents (the agent information 122) from the storage unit 12, and determines the external agent to which the uttered sentence is transmitted based on the agent information 122 and the determined intention. The agent unit 112 may determine that it is unnecessary to transmits the uttered sentence to the external agent. For example, this applies to cases in which a quick response is required or cases in which the request from the user can be completed by its own device such as when the request is a route guidance. In this case, it is possible to process the uttered sentence with only the agent unit 112 (and the local language model 121).

In this example, the following three agents are exemplified as the external agent 30.

### 1. Vehicle Agent

An external agent capable of grasping the in-vehicle situation or performing setting of in-vehicle equipment. The vehicle agent is trained on an owner's manual of the car and is also capable of providing information about functions included in the vehicle.

### 2. Casual Conversation Agent

An external agent specialized in non-task-oriented chatting.

### 3. Guidance Agent

An external agent capable of providing information about travel guidance for the user including store guidance and tourist guidance.

In this example, a guidance agent is determined as the external agent that handles the information proposal.

When the agent unit 112 transmits the uttered sentence to the determined external agent 30, the agent unit 112 adds information about the user. Examples of the information about the user may include personal information such as gender, age, height, and weight of the user. These pieces of information may be acquired from the attribute data 123 stored in the storage unit 12. As the information about the user, information about the traveling of the user may be included. As such information, information about the origin, the destination, the travel route, the transit point, and the like of the vehicle 1 can be exemplified. These pieces of information may be acquired from the route guidance unit 113. The determined external agent 30 can generate a response to the request from the user based on these pieces of information.

The response generated by the external agent 30 is transmitted to the agent unit 112 as answer sentence, and the agent unit 112 proposes information to the user via the dialogue reception unit 111 as an answer to the request. Specifically, the dialogue reception unit 111 generates speech data based on the answer sentence and outputs the speech data via the input/output unit 14. The dialogue reception unit 111 may generate only speech data that reads out the answer sentence or may generate information accompanying the speech data.

Examples of the information accompanying the speech data include a user interface screen. An answer sentence written as text may be included in the user interface screen.

Next, in step S103, a response period is set by the processing unit 114. The response period is a period of time set in order to detect whether there is a response behavior of the user toward the information proposal processing executed in step S102, and is a predetermined period of time from immediately after the proposal processing. In the present disclosure, the length of the response period is not fixed and is adjusted in accordance with the content of the proposal of information performed in step S102. For example, when the guidance information agent is determined as the external agent that handles the information proposal, the length of the response period can be adjusted in accordance with the genre of the proposed information. As one example, the processing unit 114 can adjust the response period to six months when information about a trip is proposed to the user, can adjust the response period to one month when information about a store that provides food is proposed, and can adjust the response period to one week when the information about a retail store is proposed.

As another method, when information about a specific timing is included in the proposed information, the response period may be set in consideration of the specific timing. For example, when the request from the user is a request of "wanting to go somewhere during Golden Week next year" and the information proposal in response to the request is presentation of a region to be visited during "during Golden Week next year", the response period may be adjusted as a period of time from immediately after the processing of step S102 to "Golden Week next year". Forms other than those described above can be employed in the adjustment of the response period. After the processing unit 114 adjusts the response period as above, the processing unit 114 sets the response period, and acquisition of feedback data in step S104 is prepared.

Next, in step S104, the processing unit 114 acquires feedback information about the behavior of the user. Examples of the behavior of the user include utterance and movement. Examples of the feedback data include content of an utterance by the user, an analysis result of the utterance, and a travel record (for example, the place to which the user has gone after obtaining the answer sentence). For example, the feedback data may be a text expressing an utterance of the user made after the information proposal or may be a result (for example, a numerical value indicating the degree of positivity) obtained by analyzing the utterance. The feedback data may be data expressing a reaction of the user after the information proposal. For example, the feedback data may be data expressing content of a gesture (nodding, shaking the head, and the like) made by the user. The feedback data may be data relating to the traveling of the user (for example, transition of location information and an identifier of the visited spot) after the information proposal.

The processing unit 114 acquires an utterance of the user via the input/output unit 14 and acquires a result obtained by analyzing the utterance as feedback data. The processing unit 114 may acquire operation information about the setting of the destination (travel destination) of the vehicle 1 set in the in-vehicle device 10, reaction data of the user imaged by a camera (not shown), and the like as the feedback data. Needless to say, the processing unit 114 is also capable of acquiring behaviors of the user other than the above as the feedback data.

Next, in step S105, it is determined whether the response period set in step S103 has ended. When the set response period is a relatively long period of time (for example, one week), there is a possibility that the user may stop being in the vehicle 1 and may stop the vehicle 1 in the response period. In that case, the length of a response period together with the timing in which the response period is set are stored in the storage unit 12, and when the user subsequently rides the vehicle 1, the length and the timing are read again and the processing illustrated in FIG. 4 is restarted. The processing proceeds to step S106 when step S105 is determined as positive, and the processing from step S104 is repeated again when step S105 is determined as negative.

In step S106, it is determined whether the user has taken a response behavior based on the feedback data acquired in step S104, in other words, it is determined whether there is information about a response behavior of the user in the feedback data. As one example, a case in which the guidance information agent is determined as the external agent that handles the information proposal, and the proposed information is information about a store that provides food is conceived. At this time, it can be determined that there has been a response behavior of the user when information about an operation in which the user sets the location of the store to the destination (travel destination) of the vehicle 1 in the in-vehicle device 10 is included in the feedback data or when text information about the will of the user to travel to the store is included in the text expressing the utterance, for example. Even when the user does not set the destination of the vehicle 1 in the in-vehicle device 10, it can be determined that there has been a response behavior of the user when a state in which the vehicle 1 has been located in the vicinity of the store is detected from the location information of the vehicle 1 serving as the feedback data.

As above, according to the processing illustrated in FIG. 4, in the information proposal to the user, the proposal content thereof is adjusted and set in accordance with the response period, and acquisition of feedback data in a response period thereof is performed. It becomes possible to suitably detect a response of the user to the proposal of information performed toward the user by determining whether there is a response behavior of the user based on the feedback data.

### Second Embodiment

A second embodiment of the present disclosure is described based on FIG. 6. FIG. 6 is a flowchart illustrating the flow of processing of information proposal to a user in the present embodiment. Out of the processing illustrated in FIG. 6, processing that is substantially the same as the processing illustrated in FIG. 4 is denoted by the same reference character, and hence detailed description thereof is omitted. In the processing illustrated in FIG. 6, when the processing of step S104 ends, processing of step S201 is subsequently performed.

In step S201, it is determined whether predetermined information about a positive behavior of the user toward the information proposed in step S102 is included in the feedback data acquired in step S104. A positive behavior means a behavior of the user which it cannot be said that the user has responded to the proposal of information but from which the user is relatively highly expected to respond. For example, a case in which the guidance information agent is determined as the external agent that handles the information proposal, and the proposed information is information about a store that provides food is conceived. As described above, the operation information and the like indicating that a location of a store is set to the destination of the vehicle 1 in the in-vehicle device 10 is considered to be a response behavior, but an act in which the user makes an inquiry once again about the details of the store to the agent unit 112 via the dialogue reception unit 111 after receiving the proposal of the store, for example, is handled as a positive behavior. Not only an act of making an inquiry about the details of the store but also an act of making an inquiry about stores that provide food that are similar to the store may also be handled as a positive behavior by the user. This because the will of the user to compare a plurality of stores including the proposed store with each other and determine the store to travel in the end is inferred. Regarding the positive behavior, it is also possible to employ behaviors other than those described above. The processing proceeds to step S202 when step S201 is determined as positive and the processing proceeds to step S105 when step S201 is determined as negative.

In step S202, processing of extending the response period set in step S103 is performed in response to step S201 being determined as positive. The positive behavior is a behavior from which the response behavior of the user is expected, and hence the processing is performed in order to detect the behavior with certainty. For example, when there is a positive behavior, the response period may be extended by 20%. As another method, the degree of extending the response period may be changed in accordance with the degree of positivity in the positive behavior. In other words, the response period may be extended longer as the degree of positivity in the positive behavior becomes stronger. For example, when a case in which an inquiry about the proposed store is made as the positive behavior and a case in which an inquiry about stores that provides food that are similar to the proposed store is made as the positive behavior as described above are compared to each other, the former is conceived to be stronger in the degree of positivity. Thus, the response period may be extended by 20% in the case of the former, and the response period may be extended by 10% in the case of the latter. When the processing of step S202 ends, the processing proceeds to step S105.

As above, according to the processing illustrated in FIG. 6, in the information proposal to the user, the response period thereof is adjusted and set in accordance with the proposal content, and acquisition of feedback data in a response period thereof is performed. The length of the response period may be extended in accordance with whether there is a positive behavior of the user. It becomes possible to suitably detect a response of the user to the proposal of information performed toward the user by determining whether there is a response behavior of the user based on the feedback data.

### Third Embodiment

In a third embodiment of the present disclosure, the information processing device of the present disclosure is not configured as an in-vehicle device installed in the vehicle and is configured as a server device disposed in a form that does not travel. Specifically, the server device is configured to perform information proposal for business support of the user to the user. For example, task information about the business of the user is proposed in accordance with a request from the user. As one example, the server device proposes information about a business trip application of the user or proposes a draft reply for an email received by the user. A response behavior of the user toward the information proposal by the server device as above is a behavior in which the user actually executes a task related to the proposed information. The disclosure described in the first embodiment and the second embodiment can be applied to the present embodiment in order to detect the response behavior of the user as above.

### Modification

The above-described embodiments are merely examples, and this disclosure can be implemented with changes made thereto as appropriate within such a range that no departure is made from the gist of the disclosure. For example, the processing and means described in the present disclosure can be implemented in arbitrary combinations within such a range that no technical inconsistency arises.

In the embodiment, a form in which the external agent is disposed in the external device connected to the Internet has been exemplified, but the external agent may be disposed in devices other than the above. For example, the external agent may be disposed in an edge server that can be accessed from the vehicle. The external agent may be disposed to be distributed across a plurality of edge servers or clouds. In the embodiment, the in-vehicle device 10 has been exemplified as the information processing device according to the present disclosure, but the information processing device can be implemented as a device or equipment that is not mounted on the vehicle.

When the external agents are disposed in a plurality of edge servers and the like, the in-vehicle device 10 may acquire location information of its own vehicle and determine the edge server in which the intended external agent is disposed based on the location information. For example, there are cases in which external agents that provide regional information are disposed in a plurality of edge servers each disposed for a corresponding one of regions. In this case, for example, the in-vehicle device 10 may determine an external agent disposed in an edge server that is geographically the closest based on the location information of the own vehicle. The regional information handled by the external agent may differ for each edge server. For example, an external agent that provides regional information of an area A may be disposed in an edge server disposed in the area A, and an external agent that provides regional information of an area B may be disposed in an edge server disposed in the area B. The in-vehicle device 10 determines an edge server corresponding to the area in which the own vehicle is located and accesses an external agent provided in the edge server. As a result, the in-vehicle device 10 can acquire regional information of the area.

Processing that has been described as being performed by one device may be shared and executed by a plurality of devices. Alternatively, processing that has been described as being performed by different devices may be executed by one device. In the computer system, by what hardware configuration (server configuration) each function is realized can be flexibly changed.

The present disclosure can also be realized by supplying a computer program equipped with the functions described in the above-described embodiment to a computer and making one or more processors belonging to the computer read out and execute the program. Such a computer program may be provided to a computer by a non-transitory computer-readable storage medium that can be connected to a system bus of the computer, or may be provided to a computer via a network. Examples of non-transitory computer-readable storage media include arbitrary types of discs such as magnetic discs (a floppy (R) disk, a hard disc drive (HDD), etc.) and optical discs (a CD-ROM, a DVD disc, a Blu-ray disc, etc.), a read-only memory (ROM), a random-access memory (RAM), an EPROM, an EEPROM, a magnetic card, a flash memory, an optical card, and arbitrary types of media suitable for storing electronic instructions.

What is claimed is:

1. An information processing device comprising a control unit configured to execute:
proposing information to a user;
setting, after the proposal of the information, a response period for detecting that the user has taken a response behavior toward the proposal of the information;
acquiring feedback data expressing the behavior of the user in the response period; and
determining whether the user has taken the response behavior based on the feedback data, wherein the control unit is configured to further execute adjusting a length of the response period in accordance with content of the proposal of the information in the setting of the response period.

2. The information processing device according to claim 1, wherein the control unit is configured to extend, when the feedback data includes predetermined information indicating that the behavior of the user is positive toward the proposal of the information, the response period that is set.

3. The information processing device according to claim 2, wherein the control unit is configured to change a degree of extending the response period in accordance with a degree of positivity toward the proposal of the information in the predetermined information.

4. The information processing device according to claim 1, wherein the control unit is configured to further execute:
proposing the information in accordance with a request from the user; and
adjusting the length of the response period in accordance with the content of the proposal of the information and the information about a timing related to the proposal included in the request.

5. The information processing device according to claim 1, wherein:
the information processing device is an in-vehicle device installed in a vehicle; and
the feedback data includes at least one of information about a conversation of the user in the vehicle, information about an operation of the vehicle by the user, and information about a location of the vehicle operated by the user.
